(19) United States
(12) Patent Application Publication
(10) Pub. No.: US 2025/0215295 A1
(43) Pub. Date: Jul. 3, 2025

(54) WELDING METHOD USING COATED ABRASIVE PARTICLES

(71) Applicant: Siemens Energy Global GmbH & Co. KG, Munich (DE)

(72) Inventors: Johannes Döhnert, Berlin (DE); Francis Ladru, Berlin (DE); Andre Mehlhorn, Berlin (DE); Thorsten Schulz, Berlin (DE)

(73) Assignee: Siemens Energy Global GmbH & Co. KG, Munich (DE)

(21) Appl. No.: 19/050,611

(22) Filed: Feb. 11, 2025

Related U.S. Application Data
(62) Division of application No. 17/611,153, filed on Nov. 14, 2021.

(30) Foreign Application Priority Data
May 20, 2019 (DE) 10 2019 207 350.6

(51) Int. Cl. C09K 3/14; B22F 3/24; B22F 5/04; B22F 7/08; B23K 26/342; B23K 35/32

(52) U.S. Cl. CPC C09K 3/1436; B22F 5/04; B22F 7/08; B23K 26/342; B23K 35/327; B22F 2003/242

(57) ABSTRACT

A welding method using coated abrasive particles, coated abrasive particles, coating system and sealing system which uses particles, in which a hard material layer is applied around abrasive particles such as cubic boron nitride (cBN) and protects against oxidation during welding. The hard material compound in the coating may include a carbide, in particular titanium carbide. A sealing system is composed of stator and rotor blade having the layer system.

### CROSS REFERENCE TO RELATED APPLICATIONS

This application is a divisional of U.S. application Ser. No. 17/611,153, filed Nov. 14, 2021, which is the US National Stage of International Application No. PCT/EP2020/060951 filed 20 Apr. 2020, and claims the benefit thereof. The International Application claims the benefit of German Application No. DE 10 2019 207 350.6 filed 20 May 2019.

### FIELD OF INVENTION

The invention relates to a welding method which uses particles, in which a hard material layer is applied around abrasive particles such as cubic boron nitride (cBN) and protects against oxidation during welding, a layer system and a sealing system.

### BACKGROUND OF INVENTION

The optimum gap in gas turbines or aircraft engines has a critical influence on efficiency and performance of these machines. An established system in order to set this is a rubbing-in layer on the housing side/stator (e.g. honeycombs) into which the rotating parts (e.g. turbine blades, rotor) rub.

In this way, the optimum gap is ground in, independently of manufacturing tolerances, asymmetric housing deformation, rotor displacement, etc.

Furthermore, armoring of the blade tips with cubic boron nitride (cBN) in order to protect the blade tips during rubbing-in is known: US 2015/0377039 A1.

However, the application of CBN is problematical since CBN does not form particularly good bonds with other materials. Furthermore, the embedding material (matrix) has to be resistant to high temperatures for the turbine sector. Embedding in, for example, resin derivatives as in the construction of abrasives (US 2013/004938 A1) is therefore not possible.

U.S. Pat. No. 8,308,930 B2 discloses coated particles of cubic boron nitride which have two layers of coatings.

U.S. Pat. No. 4,399,167 discloses the coating of abrasive particles with metal.

U.S. Pat. No. 10,183,312 B2 discloses coated abrasive particles with a soldering layer, where this soldering layer is the matrix of the layer to be produced.

Known manufacturing methods are electrochemical application or inductive soldering-on by means of special cBN tapes. Both are costly and technically complex.

However, a disadvantage is that in both processes, the embedding matrix is not particularly corrosion-resistant. In addition, the layer thickness cannot be set at will.

The hot gas corrosion and the corrosion of the cBN associated therewith within the first hundred hours of operation has been accepted.

### SUMMARY OF INVENTION

It is therefore an object of the invention to solve the abovementioned problem.

The object is achieved by a particle, a method, a layer system and a sealing system as claimed.

The solution has three aspects:

New corrosion-resistant matrix material MCrAlY.

MCrAlY is applied by means of laser buildup welding.

Modified cBN particles (protective envelope) Experiments have shown that pure cBN does not survive the required temperatures in the laser beam without damage. Only when hot-gas-resistant carbide coatings, in particular Tic, are used does cBN survive the residence time in the laser beam without damage.

Laser buildup welding of cBN-reinforced coatings is possible for the first time by use of the protective envelope.

The coating has increased hot gas corrosion resistance due to the particular matrix material. The functional layer can thus perform its function even after many hundred hours of operation.

Laser buildup welding allows freer definition of the layer thickness: from 0.1 mm to a number of millimeters are possible.

Very good bonding of the cBN grains in the matrix by “readily bonding” coating (TiC) of the cBN particles.

### BRIEF DESCRIPTION OF THE DRAWINGS

FIG. 1 schematically shows an illustrative particle which has been applied in an illustrative layer system as per FIG. 2.

### DETAILED DESCRIPTION OF INVENTION

The figures and the description represent merely working examples of the invention.

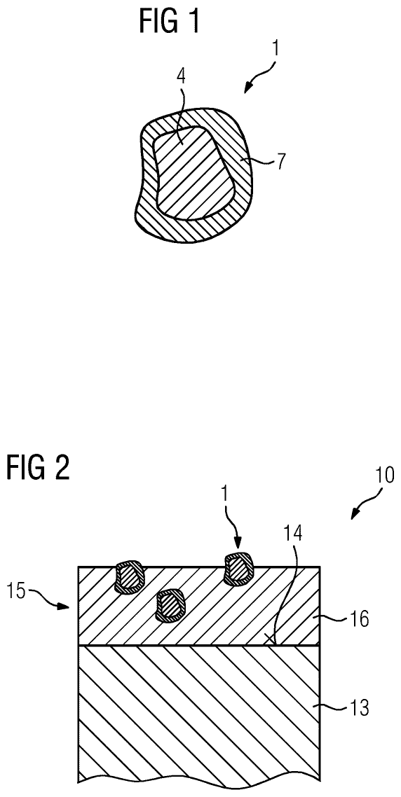

FIG. 1 shows a coated particle 4, in particular cubic boron nitride (cBN), which has a block-like particle of an abrasive material, here cubic boron nitride, in its interior, in particular consists thereof, and a coating 7 so as to form the particle 1.

To protect against oxidation during laser buildup welding, the abrasive particle 4 is enveloped by a coating 7 composed of a hard material compound, preferably a carbide, very particularly preferably titanium carbide (TiC).

Such particles 1 can be used in buildup welding processes, with these coated abrasive particles 4 being mixed with another metallic powder, preferably with a nickel-based or cobalt-based superalloy or an NiCoCrAlY alloy or pressed or incorporated in a wire which is used in a buildup welding process.

NiCoCrAlY means NiCoCrAlY+X with additions of X=tantalum (Ta), aluminum (Al), silicon (Si) and/or iron (Fe). This listing is preferably exhaustive.

The matrix material 15 is different from the abrasive particle 4 and the coating 7 thereof, since it is metallic, i.e. is preferably a metallic alloy.

Use in an SLM or SLS powder bed process is also possible.

Such a welding method and such particles 1 as per FIG. 1 make it possible to produce a layer system 10 as per FIG. 2, in which a component, preferably a turbine component, has a substrate 13 with a surface 14 and a layer 16 containing the particles has been applied to substrate 13 or to surface 14. The particles 1 are entirely within the matrix 15 in the layer 16 or project from the layer 16.

In such a sealing system, the layer 16 is then preferably applied only to the blade tip of a turbine rotor blade. The turbine rotor blade can likewise have, and in the case of gas turbines generally does have, metallic and/or ceramic coatings on the blade airfoil and/or the blade platform, but these coatings do not comprise the particles 1.

The stator or the housing of a turbine, in particular a gas turbine, also has a protective coating into which this abrasive layer 16 rubs. The coating on the housing or stator can be purely metallic, purely ceramic or comprise a layer system of a metallic bonding layer and an outer ceramic layer.

The layer or the layer system of the housing are made so that they are mechanically softer than the abrasive layer 16, so that grinding-in is possible. This can be achieved by means of the composition of the metallic or ceramic coating and/or by setting of the porosities of the layer or the layers.

1. A method for producing a layer, comprising:
using particles for producing a layer,
wherein the particles comprise an abrasive particle, and a coating of hard material compound on the abrasive particle.

2. The method as claimed in claim 1,
wherein the coating of hard material compound comprises a carbide.

3. The method as claimed in claim 1,
wherein only one coating of hard material compound is present around the abrasive particle.

4. The method as claimed in claim 1,
wherein the particles are or have been mixed with a metallic matrix material.

5. The method as claimed in claim 4, further comprising:
using a buildup welding process in which the metallic matrix material is applied together with the particles.

6. The method as claimed in claim 4,
wherein the metallic matrix material comprises NiCoCrAIY-X (X=Si, Re, Ta, Fe).

7. The method as claimed in claim 4,
wherein the metallic matrix material is a nickel-or cobalt-based superalloy.

8. The method as claimed in claim 1,
wherein the abrasive particle comprises a cubic boron nitride particle.

9. The method as claimed in claim 2,
wherein the carbide comprises titanium carbide.

10. The method as claimed in claim 3,
wherein the only one coating is composed of only one material.

11. The method as claimed in claim 5,
wherein the buildup welding process comprises a powder buildup welding process, in which a matrix material is applied together with the particles in powder form.

12. The method as claimed in claim 4, further comprising:
producing a layer system comprising a metallic substrate on at least part of which and not more than part of which the layer comprising the particles in a matrix material is present.

13. The method as claimed in claim 12,
wherein the matrix material comprises NiCoCrAIY-X (X=Si, Re, Ta, Fe).

14. The method as claimed in claim 12,
wherein the matrix material is a nickel-or cobalt-based superalloy.

15. The method as claimed in claim 12, comprising:
using the layer system on a rotor blade.

16. The method as claimed in claim 12,
wherein the matrix material consists of NiCoCrAIY-X (X=Si, Re, Ta, Fe),
wherein the abrasive particle comprises a cubic boron nitride particle, and
wherein the coating of hard material compound comprises titanium carbide.

17. The method as claimed in claim 4,
wherein the metallic matrix material consists of NiCoCrAIY-X (X=Si, Re, Ta, Fe).
